(19) United States
(12) Patent Application Publication
(10) Pub. No.: US 2012/0282160 A1
(43) Pub. Date: Nov. 8, 2012

(54) CARBON DIOXIDE AND HYDROGEN SULFIDE ABSORBENTS AND PROCESS FOR THEIR USE

(76) Inventors: Paul-Emmanuel Just, Montreal (CA); Michel A. Ouimet, Montreal (CA); Leo Ernest Hakka, Dollard-des-Ormeaux (CA); Christina Hakka, Dollard-des-Ormeaux (CA)

(21) Appl. No.: 13/386,188

(22) PCT Filed: Jul. 14, 2010
(86) PCT No.: PCT/CA2010/001101

§ 371 Date: Jul. 24, 2012

(30) Foreign Application Priority Data
Jul. 23, 2009 (CA) 2673711
Jul. 14, 2010 (CA) PCT/CA2010/001101

(51) Int. Cl. B01D 53/14; C01B 31/20

(52) U.S. Cl. 423/228; 423/437.1

(57) ABSTRACT

A process for capturing at least one of H₂S and CO₂2 from a gaseous stream comprises treating the gaseous stream with an aqueous absorbent comprising a polyamine wherein the polyamine has at least one secondary amine has at least one alkyl substituent having an absence of amine groups.

### FIELD

The specification relates to carbon dioxide and/or hydrogen sulfide absorbents and methods for their use. Particularly, the specification relates to absorbents that are usable for capturing at least one of carbon dioxide and hydrogen sulfide from a gaseous stream.

### INTRODUCTION

The following is not an admission that anything discussed below is prior art or part of the common general knowledge of persons skilled in the art.

Fossil fuels are typically combusted in industry to produce heat and/or electricity. The combustion results in the production of a stream of flue gas which contains carbon dioxide and other components. In addition, other sources of waste gas streams containing carbon dioxide, which may be produced by industry, include landfill gas, blast furnace gas and off gas from an electric arc bauxite reduction furnace.

Carbon dioxide has been identified as a green house gas. Accordingly, the amount of carbon dioxide emitted with flue gases from an industrial plant are subject to regulation in many jurisdictions. Therefore, waste gas streams, prior to being vented to the atmosphere, typically need to be treated to control the amount of carbon dioxide that is emitted to the atmosphere.

### SUMMARY

The following introduction is provided to introduce the reader to the more detailed discussion to follow. The introduction is not intended to limit or define the claims.

The present disclosure provides a class of absorbents for carbon dioxide and/or hydrogen sulfide. The absorbents in this class may have one or more of the following characteristics: a low susceptibility to degradation by SO₂, low corrosiveness to metals, and high ease of regeneration of the absorbent to a low loading of CO₂ and/or H₂S. In particular, the ability of the absorbents to be regenerated to a low loading level permits the absorbents to be useful in absorbing CO₂ and/or H₂S, and preferably CO₂, from a gas stream. The spent absorbent may then be regenerated by steam stripping to produce a waste gas stream, which may contain relatively pure CO₂ and/or H₂S. This gas stream may then be used in industry. In a preferred embodiment, the waste gas stream comprises relatively pure CO₂ and the waste gas stream may then be sequestered, such as in deep saline aquifers or in depleted oil or gas formations.

According to one broad aspect, a process for capturing at least one of H₂S and CO₂ from a gaseous stream is provided. The process comprises treating the gaseous stream with an aqueous absorbent comprising at least one polyamine of the following formula:

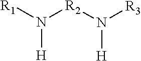

Each of R₁ and R₃ may be selected from the group consisting of H, and an alkyl substituent, provided that at least one of R₁ and R₃ is an alkyl substituent having an absence of amine groups.

R₂ may be an aliphatic carbon chain, a cyclic carbon chain, a ring structure, a secondary amine, or a tertiary amine.

If R₂ is a secondary amine, it may be of one of the following formulas:

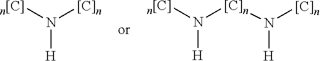

If R₂ is a tertiary amine, it may be of one of the following formulas:

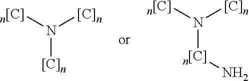

wherein one of the [C]ₙ may or may not be linked to R₁ or R₃.

If R₂ is a ring structure, it may be of the following formula:

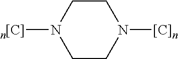

In the above formulas, n≧1 and preferably less than 4.

According to another broad aspect, a process for capturing at least one of H₂S and CO₂ from a gaseous stream is provided. The process comprises treating the gaseous stream with an aqueous absorbent comprising at least one polyamine comprising at least one secondary amine, the at least one secondary amine comprising at least one alkyl substituent having an absence of amine groups.

According to another broad aspect, a process for capturing at least one of H₂S and CO₂ from a gaseous stream comprises treating the gaseous stream with an aqueous absorbent comprising at least one polyamine having at least one sterically hindered secondary amine group, the at least one sterically hindered secondary amine group having a pKa of greater than 7.5.

According to another broad aspect, a process for capturing at least one of H₂S and CO₂ from a gaseous stream comprises treating the gaseous stream with an aqueous absorbent comprising an aliphatic polyamine, wherein the amine functionalities are secondary amines having one alkyl group selected from methyl, ethyl, propyl, isopropyl, secondary butyl or tertiary butyl bound to the nitrogen atom, preferably having an effective equivalent weight for CO₂ capture of less than 110.

### DRAWINGS

In the following description, reference will be made to the accompanying drawings, in which:

FIG. 1 is a schematic diagram of a process to capture CO₂ and/or H₂S from a feed gas stream; and

FIG. 2 is a graph showing loaded solutions analyzed by C13 NMR.

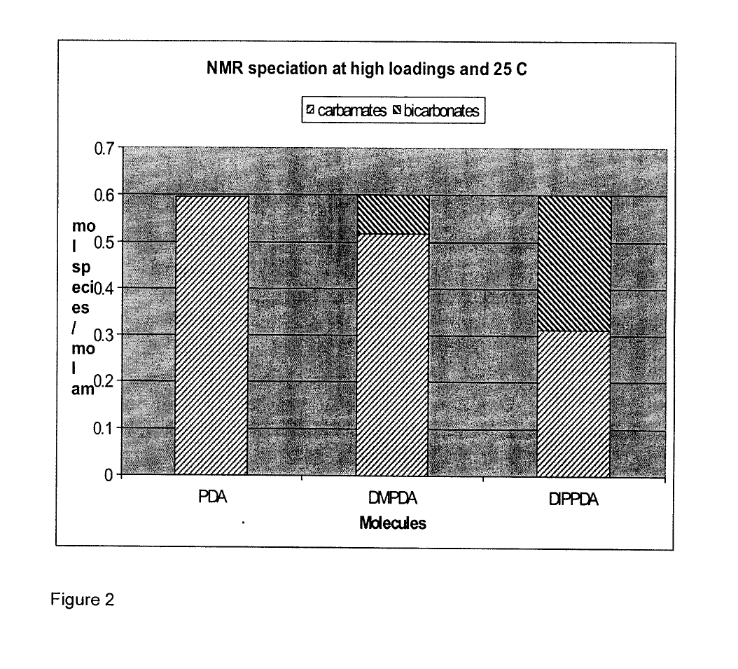

### DESCRIPTION OF VARIOUS EXAMPLES

Various apparatuses or methods will be described below to provide an example of each claimed invention. No example described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention.

### Process:

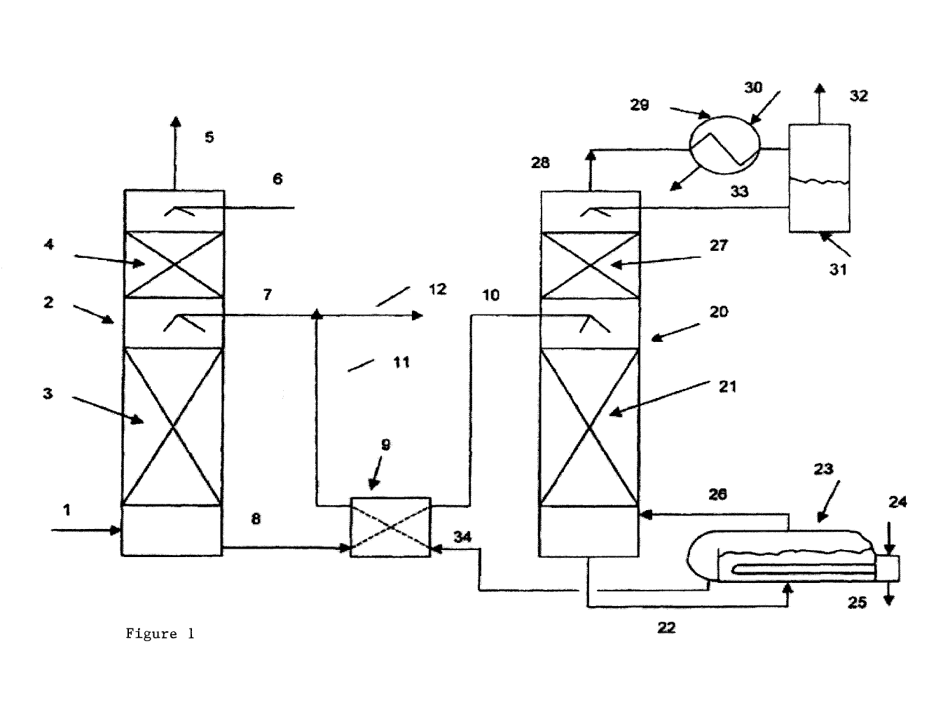

An exemplary process flow diagram is shown in FIG. 1. The exemplified process is a process for capturing CO₂ from a gaseous stream. Referring to FIG. 1, in the exemplified process, a carbon dioxide containing gaseous feed stream 1 is treated to obtain a CO₂ rich absorbent stream 8. The gaseous feed stream 1 may be any stream which contains CO₂ at levels which may require treatment for CO₂ removal before the gas is released to the atmosphere and is preferably a waste gas stream, such as flue gas streams, kiln gas, reverberatory furnace gas, fluidized catalytic cracker (FCC) regenerator off gas and the like. In alternate examples, the gaseous feed stream may contain H₂S, or CO₂ and H₂S, and the process may be a process for capturing H₂S, or CO₂ and H₂S from a gaseous stream, and may involve treating the gaseous feed stream to obtain an H₂S rich stream, or a CO₂ and H₂S rich stream.

CO₂ rich absorbent stream 8 is prepared by treating gaseous feed stream 1 with any one or more of the absorbents taught herein. As shown in FIG. 1, gaseous feed stream 1 flows into a gas-liquid contact apparatus 2. Gas-liquid contact apparatus 2 permits intimate contact between gaseous feed stream 1 and lean absorbent stream 7. Preferably, gas-liquid contact apparatus 2 is operated using counter current flow as exemplified. The apparatus 2 may be any gas-liquid contactor or absorption tower known in the art such as a spray or packed tower. FIG. 1 illustrates a packed tower, wherein gas liquid contact is promoted by suitable random or structured packing 3 in the column. CO₂ is absorbed into the lean absorbent 7, producing rich CO₂-containing absorbent, which exits from the apparatus 2 as CO₂ rich absorbent stream 8.

The gaseous feed stream 1, which is a CO₂ lean stream, and may be depleted in CO₂, is optionally washed with water (stream 6) or an acidified water stream, such as in another packed section 4, to remove absorbent that may have splashed or volatilized into the treated gas stream traveling upwardly through apparatus 2. The gas then leaves the apparatus 2 as treated gaseous feed stream 5 for either release into the atmosphere or for further treatment or use.

The water of stream 6 may be a part of the condensate stream 33 or it may be makeup water introduced to the process. The water balance in the overall process may be maintained by adding water, for example via stream 6, or withdrawing water from the process, such as by directing a part of stream 33 to waste.

In order to conserve energy, heated streams may be used to preheat cooler streams that are subsequently fed to the process equipment. For example, as shown in FIG. 1, CO₂ rich absorbent stream 8 flows through a cross flow indirect heat exchanger 9, where it is indirectly heated by stream 34 (a hot lean amine stream which is recycled to absorb CO₂), and is then introduced into regeneration tower 20 as stream 10.

Regeneration tower 20 is preferably operated using counter current flow and, more preferably, is a steam-stripping tower. In regeneration tower 20, the CO₂ rich absorbent is heated by any means known in the art to liberate CO₂ from absorbent stream 10. Preferably, absorbent stream 10 is heated indirectly by means of steam, such as in a shell and tube reboiler, but other sources of heat such as hot gas, heat transfer liquids and direct firing may be used. Heating of the stripping tower may also be effected by direct introduction of steam into the tower. As exemplified, CO₂ rich absorbent stream 10 is treated at a temperature higher than the absorption temperature in apparatus 2 to regenerate the absorbent. At this stage, CO₂ in the downwardly moving absorbent is liberated from the absorbent by upwardly moving stripping gas, e.g., steam, to produce a CO₂ rich product stream 28 and a regenerated absorbent (lean absorbent stream 22). Inert gas stripping may also be practiced for stripping the CO₂ from the CO₂ rich stream in tower 20.

Tower 20 may be of either a packed or trayed design. A packed tower with a packing section 21 is shown in FIG. 1 below the rich solvent feed level (stream 10). The rich solvent is stripped of CO₂ as it flows downward in the tower and into an optional reboiler 23. The reboiler is heated by any means known in the art. Preferably reboiler 23 is indirectly heated by stream 24 (which may be steam and may be obtained from any source) through, e.g., a heat transfer tube bundle, producing a steam condensate stream 25 which may be recycled to produce additional steam or used elsewhere in the plant. The boiling of the aqueous solvent (absorbent) in reboiler 23 produces a flow of steam 26 into the regeneration tower 20. The steam ascends through the column, heating the downward flowing absorbent and carrying upwards the CO₂ evolved from the solvent. The steam and CO₂ mixture exits the tower as stream 28.

Preferably, stream 28 is treated to remove excess water vapor contained therein. Preferably, the water vapor is removed by condensation (e.g. by means of cooling in a heat exchanger (condenser) with a cooling liquid). As shown in FIG. 1, a flow of cooling water 30 into overhead condenser 29 causes condensation of, preferably, most of the steam in stream 28, producing a 2-phase mixture, which flows into the condensate accumulator 31. The gaseous phase, which is water saturated CO₂, leaves as product stream 32 for use. The condensed water may be returned to the tower 20 as stream 33, where it flows downward through optional packed section 27. The cool condensate of stream 33 serves to wash volatilized absorbent from the vapors before they leave the tower 20 as stream 28. This helps to reduce loss of absorbent chemical with the gaseous CO₂ stream 32. It will be appreciated that additional treatment steps may be used to further limit the loss of absorbent from the process.

Preferably, hot lean amine stream 34 is used to preheat CO₂ rich absorbent stream 8. However, it will be appreciated that stream 8 may be heated by other means (e.g. by passing it through reboiler 23 or heating stream 8 upon entry to tower 20 or any combination thereof). As shown in FIG. 1, lean amine leaves regeneration tower 20 as stream 22 and enters the reboiler 23. The solvent then leaves the reboiler 23, e.g., by overflowing a weir as heated lean absorbent stream 34, which passes through the cross flow heat exchanger 9 to preheat stream 8. The lean solvent leaves heat exchanger 9 as a cooler lean absorbent stream 11, which may optionally be cooled further by a lean solvent trim cooler (not shown).

A slipstream 12 of flow from stream 11 may be treated to remove heat stable salts (HSS) and returned to, e.g., stream 11. HSS removal may be effected by any method known in the art, such as electrodialysis or ion exchange. Stream 7 enters the absorption tower 2 for capturing CO₂ from the feed stream 1.

The process may be operated with any convenient pressure in the absorber 2. If the gaseous feed stream 1 is flue gas from a boiler, which usually is operated near atmospheric pressure, then tower 2 may be operated at about atmospheric pressure or a bit below the pressure of feed stream 1 so as to favor the flow of feed gas 1 into tower 2. The regeneration tower 20 is often operated at a pressure slightly over atmospheric, generally not exceeding 3 bars absolute. The byproduct CO₂ will be at a higher pressure, helping it to flow to a downstream unit without the aid of a fan or compressor.

It will be appreciated by those skilled in the art that other absorption desorption processes may be used.

### Absorbents:

The absorbents taught herein are aqueous absorbents comprising at least one polyamine wherein the polyamine has one or more secondary amine functionalities that are available for absorbing CO₂ and/or H₂S, at least one of the secondary amine functionalities being sterically hindered without any hydroxyl functionalities.

An advantage of the adsorbents is that the secondary amine function tends to increase the amount of target gas, preferably CO₂, which may be removed from the waste gas and used to form product stream 32 for each absorption/desorption cycle of the absorbent. Accordingly, compared to a primary amine function, the level of the rich loading of the absorbent tends to be higher for the secondary amine function. Furthermore, the level of lean loading of the absorbent also tends to also be lower than for a primary amine due to easier strippability of the secondary amine function.

For example, secondary amines form amine salts of amine carbamate and may produce rich loadings of 0.5 to 1.0 moles of CO₂ per mole of amine, often as high as 0.7 moles/mole when treating coal fired flue gas at atmospheric pressure. Without being limited by theory, it is understood that this higher loading is be due to the lower stability of the carbamate when formed on a secondary amine. When formed on a secondary amine, the carbamate partly hydrolyzes to bicarbonate, a proton and the free base amine. The hydrogen ion then protonates the free base amine, yielding an amine bicarbonate salt, which has an 1:1 ratio of CO₂ to amine functionality, thereby permitting additional loading of the amine. In contrast, primary amines, which may have a pKₐ greater than about 9, tend load fully, i.e. 0.5 moles of CO₂ per mole of amine. The limit of 0.5 m/m is due to the rapid formation only of the amine salt of the amine carbamate, which requires 2 moles of amine per mole of CO₂. Similarly, the lower loading level of the regenerated (stripped) absorbent, is aided by the lower stability of the carbamate when formed on a secondary amine, so that lean loadings of 0.05-0.15 m/m are normally reached with optimum steam usage for an absorbent having secondary amine, in contrast to the 0.2-0.25 m/m for an absorbent having primary amines.

A further advantage of the adsorbents is that the secondary amine, or at least one of the secondary amines if there is more than one secondary amine, is sterically hindered and, preferably, each secondary amine is sterically hindered. The secondary amine may be sterically hindered by the provision of a bulky hydrocarbon substituent on the secondary amino function. Preferred substituents are hydrocarbon radicals which, in order of preference, are isopropyl, methyl, ethyl, secondary butyl. Without being limited by theory, it is understood that the hydrocarbon substituent has an electron donating effect, thereby effectively increasing the pKₐ of the secondary amine function. This increase in pKₐ results in the secondary amine being more basic and thereby increasing the gas loading of the absorbent. At the same time, the steric hindrance provided by the substituent hinders the formation of amine carbamate, thereby destabilizing the amine carbamate and making stripping easier. It will be appreciated that the greater the steric hindrance, the greater these effects.

The substituent that provides the steric hindrance is preferably of a limited chain length (e.g., C4 or less). The use of a smaller substituent and/or an amine with multiple sorbing secondary amines (e.g., 2 to 4) provides low equivalent weight, which provides a high normality of amine at a given weight percent of amine solution. High normality tends to increase CO₂ pickup per volume of solvent. Multiple amine functions in the absorbent tend to decrease equivalent weight and volatility.

A further advantage of the adsorbents is that there is an absence of hydroxyl functionalities. This increases the chemical stability of the absorbent. One method by which absorbents are degraded is intermolecular coupling or intramolecular cyclization through nucleophilic attack by an amine nitrogen atom on a carbon atom having a hydroxyl function as a leaving group. The use of an absorbent that does no have hydroxyl functionalities avoids this degradation.

Other methods of absorbent degradation include CO₂ mediated intermolecular coupling by nucleophilic attack by a nitrogen atom on the carbamate carbon and CO₂ mediated intramolecular cyclization by nucleophilic attack by amine nitrogen on carbamate carbon. Secondary amines are poorer nucleophiles then primary amines and sterically hindered secondary amines are even poorer nucleophiles than secondary amines without steric hindrance. Accordingly, a further advantage of the absorbents set out herein is that they are less prone to chemical degradation.

An exemplary group of polyamines comprise at least one secondary amine wherein the secondary amine preferably comprises at least one alkyl substituent having an absence of amine groups (also referred to hereinafter as “amine-absent alkyl substituents”).

For example, the polyamine may be of the following formula.

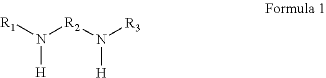

where each of R₁ and R₃ is hydrogen or an alkyl substituent, provided that at least one of R₁ and R₃ is an amine-absent alkyl substituent, i.e., has an absence of an amine group.

The amine-absent alkyl substituent(s) may be any alkyl chain, and may be branched or unbranched, saturated or unsaturated, and substituted or unsubstituted, provided that no substituents comprise amine groups. Preferably, each amine-absent alkyl substituent has 1 to 4 carbon atoms. For example, the amine-absent alkyl substituent(s) may be may be a methyl, an ethyl, a propyl, an iso-propyl, a secondary butyl, or a tertiary butyl group. More preferably, the amine-absent alkyl substituent(s) is/are relatively bulky, such that the secondary amine group(s) bonded to the amine-absent alkyl substituent is/are sterically hindered. Such bulky amine-absent alkyl substituents include, for example, iso-propyl, and t-butyl. Most preferably, the amine-absent alkyl substituent(s) is/are relatively bulky, but still have a low weight. Such substituents include, for example, iso-propyl.

In some examples, only one of R₁ and R₃ is an amine-absent alkyl substituent. In such examples, as noted hereinabove, the other of R₁ and R₃ may be, for example, hydrogen, or an alkyl substituent, which has an amine substituent. Accordingly, if one of R₁ and R₃ is hydrogen, the absorbent will have one secondary amine having an amine-absent alkyl substituent, and one primary amine. Alternately, if one of R₁ and R₃ is an alkyl substituent having an amine substituent, the absorbent will have at least two secondary amines, one of which has an amine absent alkyl substituent, and one of which has an aminated alkyl substituent. Preferably, however, each of R₁ and R₃ are amine-absent alkyl substituents, and as such, the absorbent preferably has two secondary amines having amine-absent alkyl substituents.

R₂ may be, for example, an aliphatic carbon chain, a cyclic carbon chain, an alkyl moiety containing a secondary or tertiary amine, or a ring structure. Most preferably, R₂ is selected such that the polyamine comprises at least three carbon atoms between the secondary amines.

If R₂ is an aliphatic carbon chain, it may be a straight chain, or a branched chain, may be saturated or unsaturated, and may be substituted or unsubstituted. If R₂ is a substituted aliphatic carbon chain, the substituent may comprise, for example, an amine group. For example, R₂ may be of the following formula:

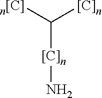

If R₂ is a cyclic carbon chain, it may be alicyclic or aromatic, saturated or unsaturated, and substituted or unsubstituted.

If R₂ is ring structure, it may be heterocyclic. For example, R₂ may comprise amine substituents. For example, R₂ may be a ring structure of the formula:

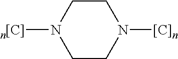

Preferably, if R₂ is an aliphatic carbon chain or a cyclic carbon chain, R₂ comprises a chain of 2 or more carbon atoms.

If R₂ is a secondary amine, it may be of one of the following formulas

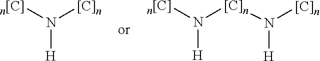

It will be appreciated that the secondary amine of R₂ may or may not be a sorbing amine.

Alternately, if R₂ is a tertiary amine, it may be of one of the following formulas:

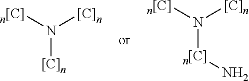

In any of the above formulas, the value of n may be greater than or equal to one, and is preferably less than four.

In any of the above formulas R₂ may or may not be linked on one of R₃ and R₁. For example, if R₂ is a tertiary amine of the formula:

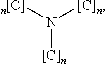

at least one of the [C]ₙ groups may linked to R₃ so that the polyamine is of the formula:

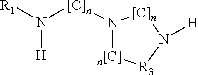

In one specific example, wherein R₃ is linked to R₂, the polyamine is of the following formula:

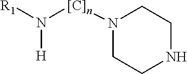

In any of the above examples, the sorbing amine groups preferably have a pKa of greater than 7.5. It is believed that a pKa of greater than 7.5 will result in increased CO₂ capture. More preferably, the polyamine has an absence of primary amine functions having a pKa of greater than 8 because these are difficult to regenerate. Further, in any of the above examples, preferably, the polyamine has an effective equivalent weight for CO₂ capture of less than 110. The “effective equivalent weight” refers to the molecular weight of the compound, divided by the number of amine groups having a pKa of greater than 7.5.

In any of the above examples, the polyamine preferably has an absence of hydroxyl functionalities.

The most preferred absorbents comprise the following compounds, in which at least one primary amine of the compound is further substituted with an amine-absent alkyl substituent to yield a secondary amine (i.e., to yield —NH—R₁, and/or —NH—R₃): diethylenetriamine, dipropylenetriamine, triethylenetetramine, 1,2-ethanediamine, 1,3-propanediamine, Tris(2-aminoethyl)amine, 3,3-bis(2-aminoethyl)aminopropane, N-(2-aminoethyl)piperazine, N-(3-aminopropyl)piperazine N,N′-bis(2-aminoethyl)piperazine or N,N′-bis(3-aminopropyl)piperazine.

For example, diethylenetriamine is of the following formula:

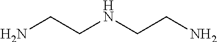

By substituting one or both of the primary amines of diethylenetriamine with an amine absent alkyl substituent to yield a secondary polyamine (i.e. to correspond to Formula 1), the preferred absorbent of the following formula is produced:

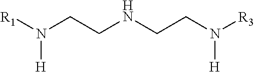

where, as noted hereinabove, each of R₁ and R₃ is a hydrogen or an alkyl substituent, provided that at least one of R₁ and R₃ is an amine-absent alkyl substituent.

The structure of the compounds listed above, as well as the preferred absorbents derived therefrom, are shown in the following table.

| | | Structure Of Preferred Absorbent In Which at least one Primary |
|---|---|---|
| Compound Having | | Amine Is Further Substituted with Amine-absent alkyl |
| Primary Amine | Structure Of Compound Having Primary Amine | substituent |
| diethylenetriamine | 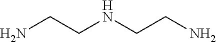 | 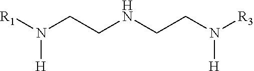 |
| triethylenetetramine | 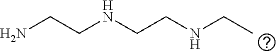 | 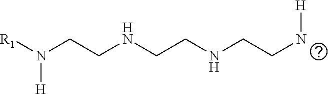 |
| 1,2-ethanediamine | 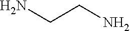 | 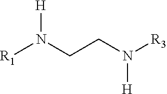 |
| 1,3-propanediamine | 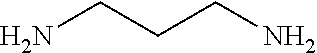 | 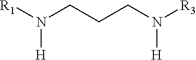 |
| Tris(2- aminoethyl)amine | 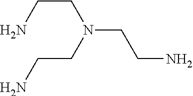 | 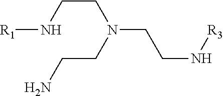 |
| 3,3-bis(2- aminoethyl)- aminopropane | 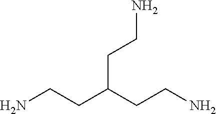 | 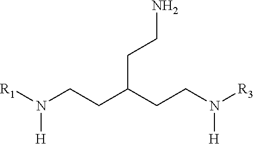 |
| N,N′-bis(2- aminoethyl)- piperazine | 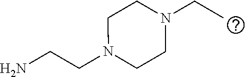 | 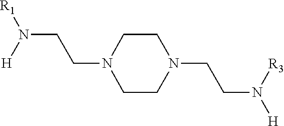 |
| N,N′-bis(3- aminopropyl)- piperazine | 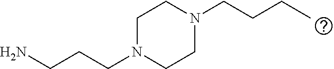 | 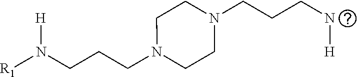 |
| dipropylenetriamine | 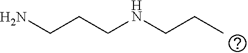 | 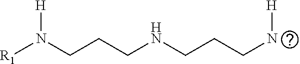 |
| N,N′-bis(2- aminopropyl)- piperazine | 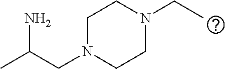 | 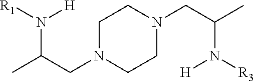 |
| N-(2-aminoethyl)- piperazine | 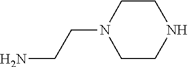 | 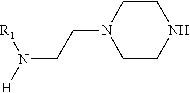 |

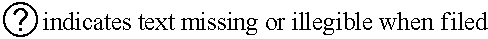

In the above compounds, all 3 of the amines in tris(2-aminoethyl)amine and 3,3-bis(2-aminoethyl)-aminopropane may be alkylated, or at least partially alkylated.

The most preferred absorbent comprises diethylenetriamine, in which both primary amines are further substituted with an isopropyl group to yield secondary amines. That is, the most preferred absorbent is of the following formula:

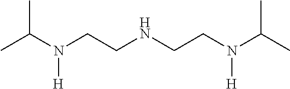

If desired, for example to counterbalance problems with viscosity or maximum solubility of the polyamine, the solvent comprising the polyamine could also comprise another tertiary amine which acts as a buffer or a physical solvent component, such as sulfolane or triethyleneglycol.

### EXAMPLES

In order to determine the nature of the carbon dioxide species in solutions in equilibrium with the amine molecule, various loaded amine absorbents were investigated by C13 NMR (Nuclear Magnetic Resonance). This technique allows for differentiation between carbamate and bicarbonate in solution. Three different amine molecules were investigated: propanediamine (PDA), in which the two terminal amino groups are unsubstituted, dimethylPropanediamine (DMPDA), in which the two terminal amino groups are methylated, and diIsopropylpropanediamine (DIPPDA), in which the two terminal amino groups are substituted with an isopropyl substituent. The aqueous solutions of these amines were sparged at 50° C. with C13 CO2 containing gas using a sintered glass bubbler, until the weight of the sample was constant. Loaded solutions were then analyzed by C13 NMR. FIG. 1 exemplifies the steric hinderance effect of a bulky substituent (i.e. isopropyl) in destabilizing the carbamate into bicarbonate, if compared to the unsubstituted or methylated molecules.

1. A process for capturing CO₂ from a gaseous stream comprising treating the gaseous stream with an aqueous absorbent comprising at least one polyamine of the formula: 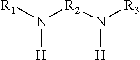
wherein the aqueous absorbent has an absence of an alkali metal salt or hydroxide, and wherein:
a) each of R₁ and R₃ is a C₃ or a C₄ alkyl substituent having an absence of amine groups and an absence of hydroxyl funcitionalities;
b) R₂ is an aliphatic carbon chain, a cyclic carbon chain, a secondary amine of the formula 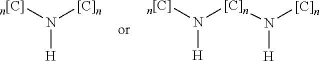
a tertiary amine of the formula 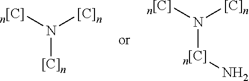
wherein one of the [C]ₙ may or may not be linked to R₁ or R₃
or a ring structure of the formula 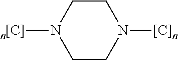
wherein n≧1.

2. (canceled)

3. The process of claim 1, wherein R₂ comprises a chain of 2 or more carbon atoms.

4. The process of claim 1, wherein R₂ comprises a cyclic amine.

5. The process of claim 1, wherein R₂ is an aliphatic carbon chain.

6. The process of claim 1, wherein R₂ comprises a secondary or a tertiary amine.

7. The process of claim 1, wherein R₂ comprises a secondary amine.

8. (canceled)

9. The process of claim 1, wherein the alkyl substituent is selected from the group consisting of isopropyl and tertiary butyl.

10. The process of claim 1, wherein at least one of the alkyl substituents is isopropyl.

11. The process of claim 1, wherein at least one of substituents is tertiary butyl.

12. The process of claim 1, wherein at least one of the polyamine has an effective equivalent weight for CO₂ capture less than 110.

13. The process of claim 1, wherein the secondary amine bonded to R₁ and the secondary amine bonded to R₃ each has a pKa of greater than 7.5.

14. The process of claim 1, wherein the at least one polyamine comprises a compound selected from the group consisting of diethylenetriamine, dipropylenetriamine, triethylenetetramine, 1,2-ethanediamine, 1,3-propanediamine, Tris(2-aminoethyl)amine, 3,3-bis(2-aminoethyl)-aminopropane, N-(2-aminoethyl)piperazine, N,N′-bis(2-aminoethyl)piperazine or N,N′-bis(3-aminopropyl)piperazine, wherein at least one primary amine of the compound is further substituted with the alkyl substituent having an absence of amine groups to yield a secondary amine.

15. (canceled)

16. The process of claim 1, wherein R₂ is a tertiary amine of the formula 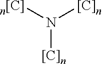
and wherein R₃ is linked to R₂ so that the polyamine is of the formula

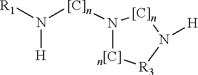

17. The process of claim 13, wherein the polyamine is of the formula:

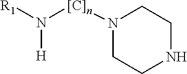

18. A process for capturing CO₂ from a gaseous stream comprising treating the gaseous stream with an aqueous absorbent comprising at least one polyamine comprising at least one secondary amine functionality, the at least one secondary amine functionality comprising at least one C₃ or C₄ alkyl substituent having an absence of amine groups the at least one polyamine has an absence of hydroxyl functionalities and primary amines and wherein the aqueous absorbent has an absence of an alkali metal salt or hydroxide.

19. (canceled)

20. The process of claim 15, wherein the alkyl substituent is isopropyl or tertiary butyl.

21. The process of claim 15, wherein the alkyl substituent is isopropyl.

22. The process of claim 15, wherein the alkyl substituent is tertiary butyl.

23. The process of claim 15, wherein the polyamine comprises two secondary amines, each having at least one-C₃ or C₄ alkyl substituent having an absence of amine groups.

24. The process of claim 15, wherein the polyamine comprises at least 3 atoms between the two secondary amines.

25. The process of claim 15, wherein the at least one polyamine comprises diethylenetriamine, dipropylenetriamine, triethylenetetramine, 1,2-ethanediamine, 1,3-propanediamine, Tris(2-aminoethyl)amine, 3,3-bis(2-aminoethyl)-aminopropane, N-(2-aminoethyl)piperazine, N,N′-bis(2-aminoethyl)piperazine or N,N′-bis(3-aminopropyl)piperazine, wherein at least one primary amine of the polyamine is further substituted with the substituent.

26. The process of claim 15, wherein the polyamine further comprises at least one of a tertiary amine, a primary amine and an additional secondary amine.

27. (canceled)

28. The process of claim 15, wherein the polyamine further comprises at least one cyclic amine.

29. The process of claim 15, wherein the at least one polyamine comprises an aliphatic polyamine.

30. The process of claim 15, wherein the polyamine has an effective equivalent weight for CO₂ capture less than 110.

31. The process of claim 15, wherein the secondary amine has a pKa of greater than 7.5.

32. The process of claim 15 further comprising obtaining a product stream of CO₂ by regenerating the absorbent.

33. (canceled)

34. A process for capturing CO₂ from a gaseous stream comprising treating the gaseous stream with an aqueous absorbent in the absence of an alkali metal salt or hydroxide, the aqueous absorbent comprising at least one polyamine having two secondary amine groups, each sterically hindered by a C₃ or a C₄ alkyl substituent, at least one of which has a pKa of greater than 7.5, wherein the polyamine has an absence of primary amine functions having a pKa greater than 8 and the at least one polyamine has an absence of hydroxyl functionalities.

35. (canceled)

36. The process of claim 28 further comprising obtaining a product stream of CO₂ by regenerating the absorbent.

37. (canceled)
